(19) United States
(12) Patent Application Publication
(10) Pub. No.: US 2022/0378164 A1
(43) Pub. Date: Dec. 1, 2022

(54) HAIR CLIP DEVICE AND KIT COMPRISING THE SAME

(71) Applicant: LAVEGLIA SERVICE SOCIETA'A RESPONSABILITA' LIMITATA, Tortona AL (IT)

(72) Inventor: Doriane CICCHIRILLO, Rivalta Bormida AL (IT)

(21) Appl. No.: 17/754,035

(22) PCT Filed: Sep. 23, 2020
(86) PCT No.: PCT/IB2020/058867

§ 371 Date: Mar. 22, 2022

(30) Foreign Application Priority Data
Sep. 23, 2019 (IT) 102019000017027

(51) Int. Cl. A45D 8/00

(52) U.S. Cl. CPC A45D 8/006; A45D 2200/25

(57) ABSTRACT

Hair clip device (10) comprising: —a front element (12) extending between a first and a second extremity (12a, 12b); —two lateral elements (13, 14) provided with a first free end (13a, 14a) configured to rest on a user's auricle; —articulation means (15) fixed to the front element (12) and to the lateral elements (13, 14) and configured to allow a rotation of the lateral elements (13, 14) with respect to the front element (12), between an open position and a closed position; —locking means (B) configured to retain the lateral elements (13, 14) in the open position with respect to the front element (12) and comprising optionally (a) first and second retaining elements (16, 17) or (b) a cantilever element (160). The front element (12) is devoid of lenses and/or of a nosepiece and is provided with at least one ornamental element (11a, 11b, 11c).

The present invention relates to a hair clip device and kit comprising the same. In particular, the present invention relates to a hair clip device and kit comprising the same, which has a structure resembling that of a pair of eye-glasses and which allows extensive and simple personalization thereof.

Nowadays hair clip devices with a curved form, also called “hairbands”, are known, these being apt to surround partially the user's head so as to retain the hair in a predetermined style.

A drawback of these hair clip devices consists in the fact that they completely fix the hair at least as regards the locks of hair with which they engage.

They in fact do not allow partial retention of the hair, namely a retaining action which limits but does not hinder the normal fluidity of the hair.

These hair clip devices are therefore suitable for use if a high degree of staticity of the hair is required.

Nowadays it is also known for persons wearing eye-glasses or sunglasses to use them as hair clip devices.

The intrinsic structure of the glasses, however, is mainly unsuitable for efficiently performing the function of a hair clip device.

If nothing else, because the nosepiece tends to press against the scalp, creating discomfort for the user, if not pain.

Therefore, when the glasses are removed from the hair, they tend to get caught up with the latter, typically in the region of the nosepiece, so that they tend to upset the stable appearance of a particular hairstyle.

The problem underlying the present invention is that of providing a hair clip device and kit comprising the same which is able to overcome the aforementioned drawbacks, allowing the hair to be partially retained in such a way as to favor the fluidity thereof, while allowing it to be kept stably in place.

The main task of the present invention consists in providing a hair clip device and kit comprising the same, able to provide a solution to said problem, while overcoming the drawbacks associated with the conventional solutions described above.

In connection with this task it is an object of the present invention to propose a hair clip device and kit comprising the same which, when worn, is stable and allow the hair to be stably retained, while allowing the partial mobility and fluidity thereof.

Another object of the present invention consists in providing a hair clip device and kit comprising the same which is able to engage with parts of the user's head so as to form areas where the hair is kept pressed, arranged alternately with areas merely defining a space suitable for receiving the hair.

Yet another object of the invention consists in proposing a hair clip device which may be easily personalized.

A further object of the invention consists in providing a hair clip device which may be folded up or has small dimensions and which is structurally simple and easy to use.

This task, as well as these and other objects which will become clearer below are achieved by a hair clip device or kit comprising the same according to the attached independent claims.

Detailed characteristics of the hair clip device and kit comprising said device according to the invention are contained in the corresponding dependent claims.

Further characteristic features and advantages will emerge more clearly form the description of a preferred, but non-exclusive embodiment of a hair clip device and kit comprising said device according to the invention, shown by way of a non-limiting example in the attached sets of drawings in which:

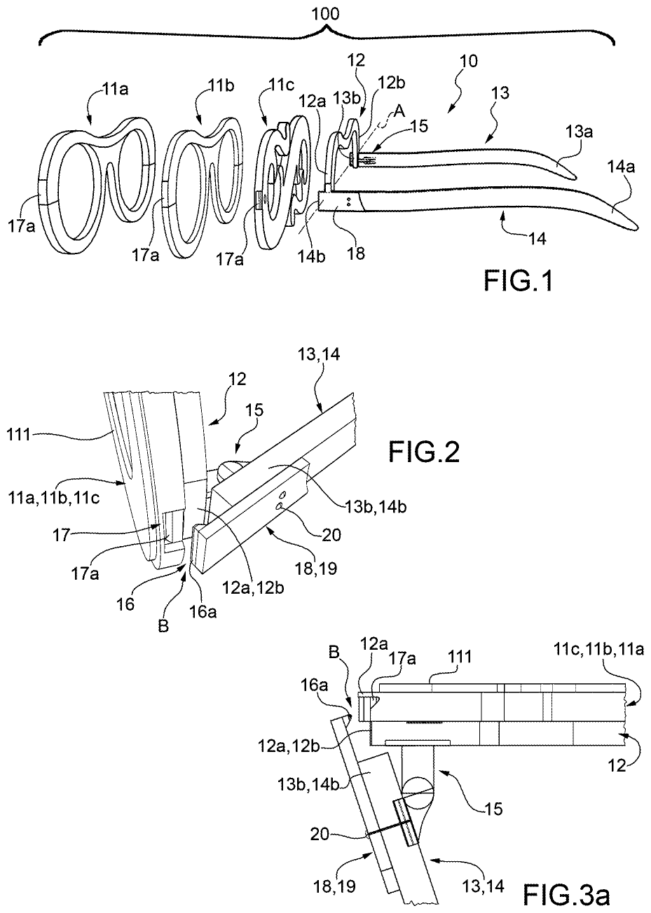

FIG. 1 shows a perspective view of a hair clip kit according to the present invention;

FIG. 2 shows a perspective view of a detail of a hair clip device according to the present invention;

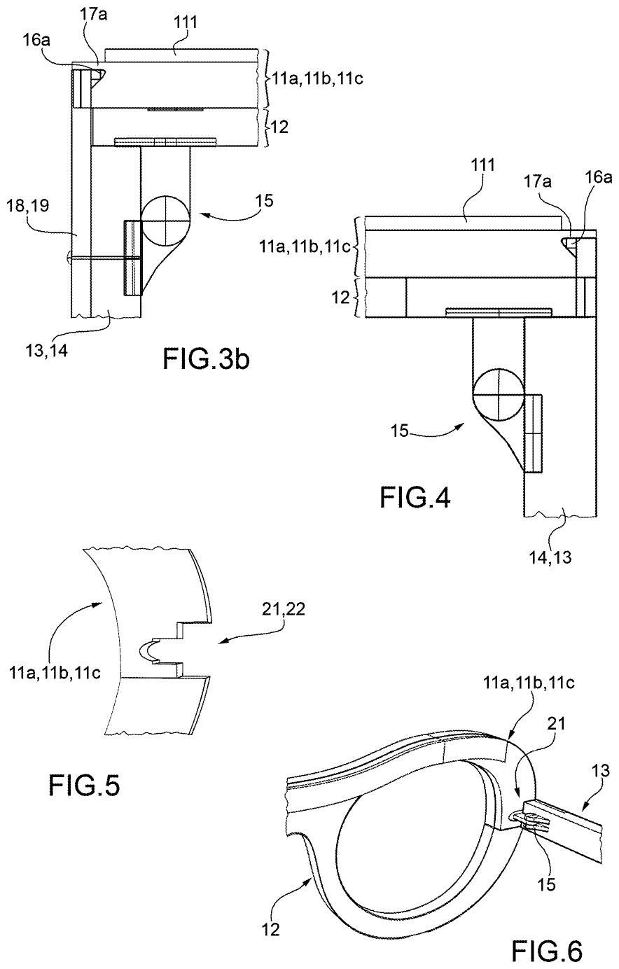

FIG. 3a shows a plan view, from above, of the detail of FIG. 2;

FIG. 3b shows a plan view, from above, of the detail of FIGS. 2 and 3, in an open position;

FIG. 4 shows a variant of the detail of FIGS. 2, 3a and 3b;

FIGS. 5 to 8 show constructional details of possible embodiments of the present invention.

With particular reference to the said figures, 100 denotes overall a hair clip kit according to the present invention.

This hair clip kit 100 comprises a hair clip device 10, described more fully below, and a plurality of ornamental elements 11a, 11b and 11c which differ in terms of aesthetic appearance so as to modify the appearance of the hair clip device 10 when they are coupled interchangeably together with the hair clip device 10.

The latter, according to the present invention, in general comprises:
a front element 12 extending between a first extremity 12a and a second extremity 12b, along a development direction A;
two lateral elements 13, 14 each provided with a first free end 13a, 14a configured to rest on the base of a user's auricle;
at least one ornamental element 11a, 11b and 11c.

The ornamental element 11a, 11b and 11c may be fixed to the front element 12 and/or to the lateral elements 13, 14 in a removable manner so as to be interchangeable and/or may comprises lenses for eye-glasses or sunglasses.

The ornamental element 11a, 11b, 11c may extend between a first extremity 11a′, 11b′, 11c′ and a second extremity 11a″, 11b″, 11c″, along a development direction A.

The hair clip device 10 may also comprise:
articulation means 15 fixed to the front element 12 and to the lateral elements 13, 14 and configured to connect each of the lateral elements 13, 14 to one of the ends of the front element 12 so as to allow a rotation of the lateral elements 13, 14 with respect to the front element 12 between an open position and a closed position;
locking means—generally indicated by the reference letter B in the attached figures—which are configured to retain the lateral elements 13, 14 in the open position with respect to the front element 12.

The articulation means 15 may comprise hinges which may be of the type, known per se, used to hingeably mount the side arms onto a front element of an eye-glasses frame.

The front element 12 of a hair clip device 10, according to the present invention, is devoid of lenses and/or a nosepiece.

Nosepiece, in the present text, is understood as meaning in general any member configured to define an anatomical support for a user's nose.

In the aforementioned closed position, the lateral elements 13 and 14 may if necessary be arranged on top of each other and rest on the front element 12 so as to minimize the overall size of the hair clip device 10.

In the open position, instead, the lateral elements 13 and 14 may form with the front element 12, at least in the vicinity of the articulation means 15, an angle which may substantially range between 60° and 120° and is optionally equal to about 90° or situated within a range of +10° to −10° about said value.

The at least one ornamental element 11a, 11b or 11c may be able to be removably coupled with the front element 12 so as to be interchangeable.

In this way the hair clip device 10 may be easily and quickly personalized by interchanging the ornamental elements 11a, 11b or 11c which may be included in the aforementioned hair clip kit 100.

FIG. 1 shows by way of a non-limiting example ornamental elements 11a, 11b and 11c which are apt to be coupled, alternately or at the same time, with the front element 12.

However, in further possible embodiments of the present invention, all to be considered as falling within the scope of protection of the attached claims, the said ornamental elements may also (or only) be apt to be coupled with the said lateral elements.

The front element 10, and specifically its development direction A, may be substantially curved or rectilinear and likewise the lateral elements 13 and 14 may extend along a curved and/or rectilinear direction.

The locking means B may comprise first retaining elements 16 and second retaining elements 17. The first retaining elements 16 may be fixable or fixed to the lateral elements 13, 14, while the second retaining elements 17 may be fixable or fixed to the front element 12 and/or to the ornamental element 11a, 11b, 11c.

In particular, the first retaining elements 16 may be fixable or fixed to a second end 13b, 14b of the lateral elements 13, 14 opposite to the first end 13a, 14a.

The second retaining elements 17 may be fixable or fixed to the first end 12a and to the second end 12b, correspondingly, of the front element 12.

Alternatively or in addition, the second retaining elements 17 may be fixable or fixed to the first extremity 11a′, 11b′, 11c′ and to the second extremity 11a″, 11b″, 11c″ of the ornamental element 11a, 11b or 11c.

The first and second retaining elements 16 and 17 may be positioned on the lateral elements 13, 14 and on the front element 12 and/or on the ornamental element 11a, 11b, 11c so that:
in said open position, the first retaining elements 16 engage with the second retaining elements 17; and
in said closed position, the first and second retaining elements 16 and 17 are not operative, namely they are not engaged together.

The retaining elements 16 and 17 may be magnetic or magnetically reactive so that they can be coupled together magnetically.

Alternatively, the retaining elements 16 and 17 may be configured so that they can be coupled together mechanically, for example by means of snap-engagement.

Furthermore, the retaining elements 16 and 17 may be both magnetic or magnetically reactive so that they can be coupled together magnetically and also configured to be coupled together mechanically.

The retaining elements 16, 17 may respectively comprise a tooth 16a and a recess 17a which complement each other.

The tooth 16a and the recess 17a may be positioned so that, in the open position, the tooth 16a engages the recess 17a being coupled with it so that, once they are engaged, the mechanical cooperation between tooth 16a and recess 17a opposes the movement out of the open position and consequently the movement into the closed position.

The tooth 16a or recess 17a may be integral with each of the lateral elements 13, 14, as for example shown in the non-limiting example of FIG. 4.

In this case, for example, the tooth 16a may project from each lateral element 13, 14 or from a protuberance integral therewith, so as to engage, in the open position, inside the corresponding recess 17a.

Alternatively, as shown by way of a non-limiting example in FIGS. 2, 3a and 3b, the teeth 16a may be integral with an additional component 18, 19 which can be fixed to the lateral elements 13, 14.

Each additional component 18, 19 may be fixed to a corresponding lateral element 13, 14 removably, for example by means of screws 20, or in a fixed manner, for example by means of welding.

In general, the recess 17a may be formed on an end face of the first extremity 12a and the second extremity 12b of the front element 12.

Said end face may be substantially perpendicular to a development direction A such that the recess will extend essentially parallel to the development direction A or, at least along a direction which will have a non-zero component along the development direction A.

Clearly, the recess instead may be formed on a front face, namely a face which during use is “visible” and extends substantially parallel to the development direction A or, in any case, in a direction not perpendicular to the latter.

In this case the lateral elements 13 and 14 will be suitably configured to extend so that the corresponding teeth 16a are in an ideal position for engagement with the recesses 17a when the open position is reached.

In the case where the teeth 16a are provided on the additional components 18 and 19, clearly the latter will be formed in the manner described above.

In the example described here, by way of a non-limiting example, the teeth 16a project from the lateral elements 13 and 14 or from the additional components 18, 19 fixed thereto, and the recesses 17a described are provided on the front element 12, however, the reverse solution kinematically speaking also falls within the scope of the present disclosure, namely the solution where the teeth 16a project from the front element 12 or from an additional component thereof and the recesses 17a are formed on the lateral elements 13, 14, the description given hitherto also being applicable, mutatis mutandis.

In a further embodiment, shown by way of a non-limiting example in the attached FIGS. 1 to 4, still within the scope of the present disclosure, the recesses 17a, or the teeth 16a, may be provided on one of the said ornamental elements 11a, 11b or 11c so that the movement of the lateral elements 13, 14 into the closed position is followed by the engagement of the teeth 16a with the recesses 17a and simultaneous locking, in the open position, of the lateral elements 13, 14 with respect to the front element 12 and the retention of said ornamental element 11a, 11 or 11c on the said front element 12.

In other words, either one of said tooth 16a and said recess 17a is associated or may be associated with the lateral elements 13, 14 and the other one of said recess 17a or tooth 16a may be provided on the front element 12 or on the ornamental element 11a, 11b, 11c so that the movement of the lateral elements 13, 14 into the closed position is followed by the engagement of the teeth 16a with the recesses 17a and the simultaneous locking, in the open position, of the lateral elements 13, 14 with respect to the front element 12 and the retention of the ornamental element 11a, 11b or 11c on the said front element 12.

In general, the recess 17a may be formed on an end face of the extremity of the ornamental element 11a, 11b or 11c.

Similarly to that already described further above, said end face may be substantially perpendicular to the development direction A such that the recess 17a will extend essentially parallel to the development direction A or, at least along a direction which will have a non-zero component along the development direction A.

The recess 17a may instead be formed on a front face 111 of the ornamental element 11a, 11b or 11c which extends substantially parallel to the development direction A or in any case, not perpendicular to the latter.

In this case the lateral elements 13 and 14 will be suitably configured to extend so that the corresponding teeth 16a are in an suitable position for engaging with the recesses 17a when the open position is reached.

In the case where the teeth 16a are provided on the additional components 18 and 19, clearly the latter will be suitably formed.

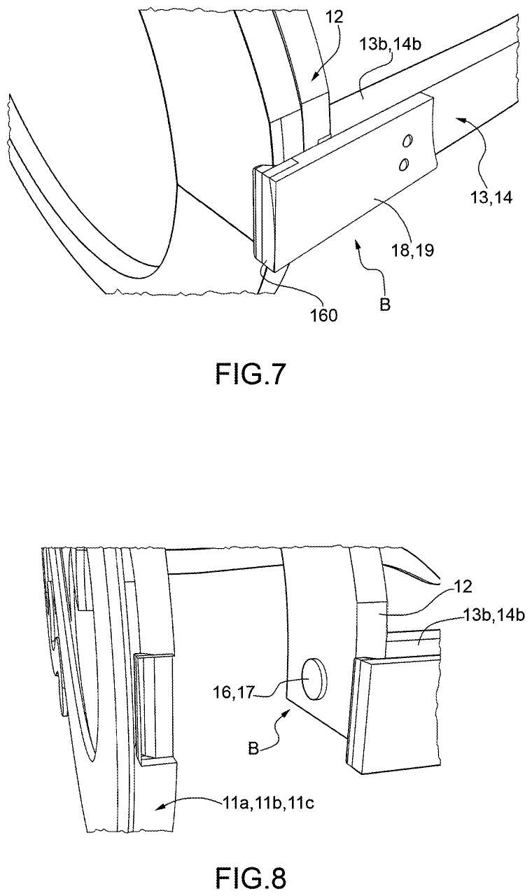

As shown by way of example in FIG. 7, the locking means B may also comprise a cantilever element 160 which may consist of a bracket-shaped or toothed-shaped portion configured to be arranged, in the open position of the lateral elements 13 and 14, at least partly on the front element 12 and/or on an ornamental element 11a, 11b, 11c.

The cantilever element 160 may extend at least mainly along the development direction A.

The cantilever element 160 may be fixed to a second extremity 13b, 14b of each lateral element 13, 14 in a removable manner, for example by means of screws 20, or may be integral with, namely be made as one piece with, a second extremity 13b, 14b of the latter.

Alternatively, the cantilever element 160 may be integral with one of said additional elements 18, 19.

Therefore, the cantilever element 160 is configured so that, when a lateral element 13, 14 which carries it is in the open position, it engages part of the front face of the front element 12 or the front face 111 of the ornamental element 11a, 11b or 11c.

In particular, the retaining action of the lateral elements 13 and 14 in the open position is provided by at least the mechanical form-fitting interaction between the cantilever element 160 and the front element 12 or an ornamental element 11a, 11b or 11c.

The ornamental element 11a, 11b or 11c may be autonomous with respect to the front element 12 and means may be provided for temporarily fixing the ornamental element 11a, 11b or 11c to the front element 12 and/or to the lateral elements 13 and/or 14 (not shown in the attached figures).

Said means for fixing the ornamental element 11a, 11b or 11c to the front element 12 and/or to the lateral elements 13 and/or 14 may be magnetic means or mechanical means, such as ratchet elements which are apt to snap-engage, namely by means of momentary elastic deformation, with correspondingly counter-shaped undercuts in a manner known per se and not shown in the attached figures.

The hair clip device 10 may also comprise auxiliary aesthetic elements which may differ in terms of aesthetic appearance from the ornamental element 11a, 11b or 11c so as to modify the appearance of said hair clip device 10 when they are applied or interchanged.

In fact, said auxiliary aesthetic elements may consist for example of additional accessories, such as charms or rhinestones, which act as further aesthetic characterization elements apt to help personalize and/or make more attractive the aesthetic appearance of the hair clip device 10.

The auxiliary aesthetic elements may be configured to be fixed or coupled together with the front element 12 and/or the lateral elements 13, 14 and/or one or more ornamental elements 11a, 11b or 11c in a magnetic and/or mechanical, interchangeable or stable manner. The ornamental element 11a, 11b or 11c may be configured to be coupled together with the front element 12 when the lateral elements 13, 14 are in the open position and to lock the lateral elements 13, 14 in the open position.

For this purpose, for example, the ornamental element 11a, 11b or 11c may comprise shaped ends 21, 22 apt to be coupled with the articulation means 15, when the lateral elements 13, 14 are in the open position, so as to lock the articulation means 15 and prevent or oppose the movement of the lateral elements 13, 14 from the open position.

In this case the locking means B may consist of said shaped ends 21, 22 or will include them.

As already mentioned above, the development direction A may be substantially rectilinear and the lateral elements 13, 14 may each extend along a corresponding extension direction which may, in turn, be substantially rectilinear and which, in said open position, may be substantially perpendicular to the development direction A.

In this way, both the front element 12 and the lateral elements 13 and 14 will be apt to engage with a user's head only in limited zones and, specifically, an upper central zone of the skull, which is engaged during use by the central element 12, and a zone in the region of the temples, which is engaged by each lateral element 13, 14.

Thus the hair, except in the aforementioned zones, will be contained by the hair clip device according to the present invention, but not compressed against the head so as to allow it to maintain its natural mobility and fluidity.

The front element 12 and the lateral elements 13, 14 may be integral with each other and joined by an articulation part, which is elastically or plastically deformable so as to allow the relative movement of the front element 12 and the said lateral elements 13, 14.

In this case, the articulation means 15 will be formed by said articulation part.

Or else, the front element 12 and the lateral elements 13, 14 will be joined together and will form a single body or will be fixed together so that they cannot be adjusted directionally with respect to each other during normal use of the hair clip device 10.

The front element 12 and the lateral elements 13, 14 may also have areas which are covered with a material suitable for preventing sliding on the user's head, for example areas covered with silicone.

These areas may be provided in positions of the front element 12 and the lateral elements 13, 14 which are intended to come into contact with the user's head when the hair clip device 10 is worn.

The front element 12 and the lateral elements 13, 14 may also be connected together removably so that the lateral elements 13, 14 are interchangeable with respect to the front element 12 and vice versa.

Moreover, the front element 12 and/or the lateral elements 13, 14 may be at least partially curved so as to have at least a concave portion with respect to the space apt to receive the user's head, this space being partially surrounded by the front element 12 and by the lateral elements 13, 14 when they are in the open position.

The hair clip device 10 or the hair clip kit 10 may also include an electric or electronic device, such as a battery, a video camera, a photographic camera, earphones, a global positioning system (GPS), a bar code reader or QR code reader.

Said electronic device may be fixed or coupled, stably or removably, together with a housing seat in the hair clip device 10.

The hair clip device 10 may comprise at least one housing seat apt to receive or support or connect said electronic device. This housing seat may be formed on a lateral element 13, 14 and/or on the front element 12, and/or on an ornamental element 11a, 11b or 11c, for example it may be formed inside a lateral element 13, 14 and/or the front element 12 and/or an ornamental element 11a, 11b or 11c or inside a container component fixed thereto.

A hair clip kit 100, according to the present invention, may also comprise a plurality of said auxiliary aesthetic elements, where said auxiliary aesthetic elements may differ in terms of aesthetic appearance so as to modify the appearance of the hair clip device 10 when they are applied or interchanged.

Alternatively, at least one of said auxiliary aesthetic elements and at least one of said ornamental elements may be aesthetically complementary, so as to form a set apt to give a harmonious appearance to a hair clip device 10 which includes them.

It can therefore be understood how a hair clip device 10 and kit 100 comprising said device, according to the present invention, is able to overcome the drawbacks mentioned above, allowing partial retention of the hair in such a way as to favor the fluidity thereof, while allowing it to be stably retained.

In detail, a hair clip device 10 and kit 100 comprising said device, according to the invention, when worn, is stable and allows the hair to be stably retained, while allowing the partial mobility and fluidity thereof.

Therefore a hair clip device 10 and kit 100 comprising said device, according to present invention, is able to engage with parts of the user's head so as to form certain areas where the hair is kept pressed, arranged alternately with areas merely defining a space suitable for receiving the hair.

Furthermore, a hair clip device 10 and kit 100 comprising said device, according to the present invention, may be easily personalized.

Last but not least, an advantage of a hair clip device 10 and kit 100 comprising the latter, according to the present invention, is that it may be folded or has small dimensions and is structurally simple and easy to use.

The invention thus devised may be subject to numerous modifications and variations, all of which fall within the scope of protection of the attached claims.

Moreover all the details may be replaced by other technically equivalent elements.

In practice the materials used as well as the associated forms and dimensions may be varied depending on the particular requirements and the state of the art. Where the constructional characteristics and the techniques mentioned in the following claims are followed by reference numbers or symbols, these reference numbers or symbols have been assigned with the sole purpose of facilitating understanding of the said claims and consequently they do not limit in any way the interpretation of each element which is identified, purely by way of example, by said reference numbers or symbols.

1. A hair clip device (10) comprising:
a front element (12) extending between a first extremity (12a) and a second extremity (12b), along a development direction (A); said front element (12) is devoid of lenses and/or of a nosepiece;
two lateral elements (13, 14) each provided with a free first end (13a, 14a) configured to rest on the base of a user's auricle;
at least one ornamental element (11a, 11b, 11c) which can be fixed to said front element in a removable way so as to be interchangeable;
articulation means (15) fixed to said front element (12) and to said lateral elements (13, 14) and configured to connect each of said lateral elements (13, 14) to one of said extremities (12a, 12b) of the front element (12) so as to allow a rotation of said lateral elements (13, 14) with respect to said front element (12) between an open position and a closed position;
locking means (B) configured to retain said lateral elements (13, 14) in said open position with respect to said front element (12);
wherein said locking means (B) comprise (a) first and second retaining elements (16, 17) or (b) a cantilever element (160);
wherein for alternative (a) said first retaining elements (16) are fixable or fixed to said lateral elements (13, 14) and said second retaining elements (17) are fixable or fixed to said front element (12) and/or to said ornamental element (11a, 11b, 11c); said first and second retaining elements (16, 17) being positioned on said lateral elements (13, 14) and on said front element (12) and/or on said ornamental element (11a, 11b, 11c) in such a way that:
in said open position, said first retaining elements (16) engage said second retaining elements (17);
in said closed position said first retaining elements (16) and said second retaining elements (17) are not operative;
wherein for alternative (b) said cantilever element (160) extends mainly, rectilinearly or substantially rectilinearly, along said development direction (A) and wherein said cantilever element (160) is integral with or removably fixable to a second extremity (13b, 14b) of said lateral elements (13, 14) or is integral with an additional component (18, 19) connectable to said lateral elements (13, 14) and said cantilever element (160) is configured to overlap at least partially the front element (12) and/or to an ornamental element (11a, 11b, 11c) when said lateral elements (13, 14) are in said open position.

2. The hair clip device (10) according to claim 1, wherein for said alternative (a) said retaining elements (16, 17) are magnetic or magnetically reactive so that they can be magnetically coupled together and/or are configured to be mechanically coupled together.

3. The hair clip device (10 according to claim 1, wherein for said alternative (a) said first retaining elements (16) are fixable or fixed to a second end (13b, 14b) of said lateral elements (13, 14), opposite to the first end (13a, 14a), and wherein said second retaining elements (17) are fixable or fixed to said first extremity (12a) and to said second extremity (12b), correspondingly, of said front element (12) and/or wherein said ornamental element (11a, 11b, 11c) extends between a first extremity (11a′, 11b′, 11c′) and a second extremity (11a″, 11b″, 11c″), along the development direction A, and said second retaining elements (17) are fixable or fixed to said first extremity (11a′, 11b′, 11c′) and second extremity (11a″, 11b″, 11c″) of the ornamental element.

4. The hair clip device (10) according to claim 3, wherein for said alternative (a) said retaining elements (16, 17) comprise a tooth (16a) and a recess (17a), mutually complementary, arranged such that in said open position said tooth (16a) engages said recess (17a) being coupled with it so as to oppose the movement into said closed position; wherein said tooth (16a) or said recess (17a) are integral with each of said lateral elements (13, 14) or are integral with an additional component (18, 19) fixable to said lateral elements (13, 14).

5. The hair clip device (10) according to claim 4, wherein either one of said recess (17a) or said tooth (16a) is provided on said at least one ornamental element (11a, 11b or 11c) and/or on said front element (12) so that the movement into the closed position of the lateral elements (13, 14) is followed by the engagement of said tooth (16a) with said recess (17a) and the simultaneous locking in the closed position of the lateral elements (13, 14) with respect to the front element (12) and the retention of said ornamental element (11a, 11b or 11c) together with said front element (12).

6. The hair clip device (10) according to claim 1, wherein said ornamental element (11a, 11b, 11c) is autonomous with respect to said front element (12) and means are provided for temporarily fixing said ornamental element (11a, 11b, 11c) to said front element (12), said means being magnetic means or mechanical means.

7. The hair clip device (10) according to claim 1, comprising auxiliary aesthetic elements configured to be fixed or coupled together with said front element (12) and/or said lateral elements (13, 14) and/or an ornamental element (11a, 11b, 11c) in a magnetic and/or mechanical manner and interchangeable or stable manner.

8. The hair clip device (10) according to claim 1, wherein said ornamental element (11a, 11b, 11c) is configured to be coupled with said front element (12) when said lateral elements (13, 14) are in said open position and to lock said lateral elements (13, 14) in said open position.

9. The hair clip device (10) according to claim 1, wherein said development direction (A) is substantially rectilinear and each of said lateral elements (13, 14) extends along its own extension direction which is substantially rectilinear and wherein, in said open position, said extension direction is substantially perpendicular to said development direction (A).

10. The hair clip device (10) according to claim 1, wherein said front element (12) and said lateral elements (13, 14) are mutually integral and joined by an articulation part, elastically or plastically deformable to allow the relative movement of said front element (12) and said lateral elements (13, 14).

11. The hair clip device (10) according to claim 1, wherein said front element (12) and said lateral elements (13, 14) have areas covered by a material suitable for preventing sliding on the user's head, for example areas covered with silicone; said areas being arranged in positions of said front element (12) and said lateral elements (13, 14) designed to come into contact with the user's head when said hair clip device (10) is worn.

12. The hair clip device (10) according to claim 1, wherein said front element (12) and said lateral elements (13, 14) are connected together in a detachable way so that said lateral elements (13, 14) are interchangeable with respect to said front element (12) and vice versa.

13. The hair clip device (10) according to claim 1, wherein said front element (12) and/or said lateral elements (13, 14) are at least partially curved so as to have at least one concave portion with respect to the space for receiving the user's head, which is partially surrounded by said front element (12) and by said lateral elements (13, 14) when they are in said open position.

14. The hair clip device (10) according claim 1 comprising an electric or electronic device.

15. The hair clip device (10) according to claim 1, comprising at least one seat for housing an electric or electronic device on a lateral element (13, 14) and/or on the front element 12 and/or on an ornamental element (11a, 11b or 11c).

16. The hair clip kit (100) comprising the hair clip device (10) according to claim 1 and a plurality of said ornamental elements (11a, 11b, 11c) wherein the ornamental elements (11a, 11b, 11c) of said plurality differ in appearance so as to modify the appearance of said hair clip device (10) when they are interchanged.

17. The hair clip kit (100) according to claim 16, said hair clip kit comprises a plurality of said auxiliary aesthetic elements, wherein said auxiliary aesthetic elements differ in appearance so as to modify the appearance of said hair clip device (10) when they are applied or interchanged.

18. The hair clip kit (100) according to claim 17, wherein at least one of said auxiliary aesthetic elements and at least one of said ornamental elements (11a, 11b, 11c) are aesthetically complementary so as to form a set able to give a harmonious aesthetic appearance to a hair clip device (10) which includes them.

19. The hair clip device (10) according to claim 2, wherein for said alternative (a) said first retaining elements (16) are fixable or fixed to a second end (13b, 14b) of said lateral elements (13, 14), opposite to the first end (13a, 14a), and wherein said second retaining elements (17) are fixable or fixed to said first extremity (12a) and to said second extremity (12b), correspondingly, of said front element (12) and/or wherein said ornamental element (11a, 11b, 11c) extends between a first extremity (11a′, 11b′, 11c′) and a second extremity (11a″, 11b″, 11c″), along the development direction A, and said second retaining elements (17) are fixable or fixed to said first extremity (11a′, 11b′, 11c′) and second extremity (11a″, 11b″, 11c″) of the ornamental element.

20. The hair clip device (10) according to claim 19, wherein for said alternative (a) said retaining elements (16, 17) comprise a tooth (16a) and a recess (17a), mutually complementary, arranged such that in said open position said tooth (16a) engages said recess (17a) being coupled with it so as to oppose the movement into said closed position; wherein said tooth (16a) or said recess (17a) are integral with each of said lateral elements (13, 14) or are integral with an additional component (18, 19) fixable to said lateral elements (13, 14).

21. The hair clip device (10) according to claim 20, wherein either one of said recess (17a) or said tooth (16a) is provided on said at least one ornamental element (11a, 11b or 11c) and/or on said front element (12) so that the movement into the closed position of the lateral elements (13, 14) is followed by the engagement of said tooth (16a) with said recess (17a) and the simultaneous locking in the closed position of the lateral elements (13, 14) with respect to the front element (12) and the retention of said ornamental element (11a, 11b or 11c) together with said front element (12).

22. The hair clip kit (100) according to claim 21, wherein at least one of said auxiliary aesthetic elements and at least one of said ornamental elements (11a, 11b, 11c) are aesthetically complementary so as to form a set able to give a harmonious aesthetic appearance to a hair clip device (10) which includes them.

23. The hair clip kit (100) comprising a hair clip device (10) according to claim 6 and a plurality of said ornamental elements (11a, 11b, 11c) wherein the ornamental elements (11a, 11b, 11c) of said plurality differ in appearance so as to modify the appearance of said hair clip device (10) when they are interchanged.
